(19) United States
(12) Patent Application Publication
(10) Pub. No.: US 2020/0075203 A1
(43) Pub. Date: Mar. 5, 2020

(54) MAGNET MATERIAL, PERMANENT MAGNET, ROTARY ELECTRIC MACHINE, AND VEHICLE

(71) Applicant: KABUSHIKI KAISHA TOSHIBA, Tokyo (JP)

(72) Inventors: Masaya Hagiwara, Yokohama Kanagawa (JP); Shinya Sakurada, Shinagawa Tokyo (JP); Naoyuki Sanada, Yokohama Kanagawa (JP)

(21) Appl. No.: 16/283,873

(22) Filed: Feb. 25, 2019

(30) Foreign Application Priority Data
Aug. 30, 2018 (JP) 2018-161663

(51) Int. Cl. H01F 1/059; H01F 1/058; H01F 1/055

(52) U.S. Cl. CPC H01F 1/0593; C22C 38/005; H01F 1/0557; H01F 1/058

(57) ABSTRACT

A magnet material is expressed by a composition formula 1: (R₁₋ₓYₓ)ₐM_{b}T_{c}, and includes a main phase having a ThMn₁₂ crystal phase. A total amount of at least one sub-phase selected from the group consisting of a Th₂Zn₁₇ crystal phase, a Th₂Ni₁₇ crystal phase, a TbCu₇ crystal phase, and an Nd₃(Fe, Ti)₂₉ crystal phase is 20 volume % or less. A total amount of at least one hetero-phase selected from the group consisting of an α-Fe phase and an α-(Fe, Co) phase is 5 volume % or less. An average crystal grain size of the main phase is 4 μm or more.

### CROSS REFERENCE TO RELATED APPLICATION

This application is based upon and claims the benefit of priority from Japanese Patent Application No. 2018-161663, filed on Aug. 30, 2018; the entire contents of which are incorporated herein by reference.

### FIELD

Embodiments described herein relate generally to a magnet material, a permanent magnet, a rotary electric machine, and a vehicle.

### BACKGROUND

Permanent magnets are used for products in wide fields including, for example, rotary electric machines such as motors and generators, electric devices such as speakers and measurement instruments, and vehicles such as automobiles and railway vehicles. In recent years, a demand for size reduction of the above-stated products has been increasing, and high-performance permanent magnets with high magnetization and high coercive force are demanded.

Examples of high-performance permanent magnets include, for example, rare-earth magnets such as Sm—Co based magnets and Nd—Fe—B based magnets. In these magnets, Fe and Co contribute to increase in saturation magnetization. Further, these magnets contain rare-earth elements such as Nd and Sm, which bring about large magnetic anisotropy originating in behaviors of 4f electrons of the rare-earth elements in crystal fields. Large coercive force is thereby able to be obtained.

### BRIEF DESCRIPTION OF THE DRAWINGS

FIG. 1 is a cross-sectional schematic view illustrating a structure example of a metal structure.

FIG. 2 is a schematic view of M-H curves of magnet materials.

FIG. 3 is a schematic view of M-H curves of magnet materials.

FIG. 4 is a view illustrating an example of a permanent magnet motor.

FIG. 5 is a view illustrating an example of a variable magnetic flux motor.

FIG. 6 is a view illustrating an example of a generator.

FIG. 7 is a schematic view illustrating a configuration example of a railway vehicle.

FIG. 8 is a schematic view illustrating a configuration example of an automobile.

### DETAILED DESCRIPTION

A magnet material of an embodiment is expressed by a composition formula 1: (R₁₋ₓYₓ)ₐM_{b}T_{c}. R is one element selected from the group consisting of rare-earth elements, T is at least one element selected from the group consisting of Ti, V, Nb, Ta, Mo, and W, M is Fe or Fe and Co, x is a number satisfying 0.01≤x≤0.8, a is a number satisfying 4≤a≤20 atomic %, c is a number satisfying 0<c<7 atomic %, and b is a number satisfying b=100−a−c atomic %. The magnet includes a main phase having a ThMn₁₂ crystal phase. A total amount of at least one sub-phase selected from the group consisting of a Th₂Zn₁₇ crystal phase, a Th₂Ni₁₇ crystal phase, a TbCu₇ crystal phase, and an Nd₃(Fe, Ti)₂₉ crystal phase is 20 volume % or less. A total amount of at least one hetero-phase selected from the group consisting of an a-Fe phase and an α-(Fe, Co) phase is 5 volume % or less. An average crystal grain size of the main phase is 4 μm or more.

Hereinafter, embodiments will be explained with reference to the drawings. Note that the drawings are schematic, and for example, a relation between a thickness and a plane dimension, a ratio of thicknesses of the respective layers, and the like are sometimes different from actual ones. Moreover, in the embodiments, substantially the same components are denoted by the same reference signs, and explanations thereof are omitted.

### First Embodiment

A magnet material of this embodiment contains a rare-earth element, an element M (M is Fe or Fe and Co), and an element T (at least one element selected from the group consisting of Ti, V, Nb, Ta, Mo, and W).

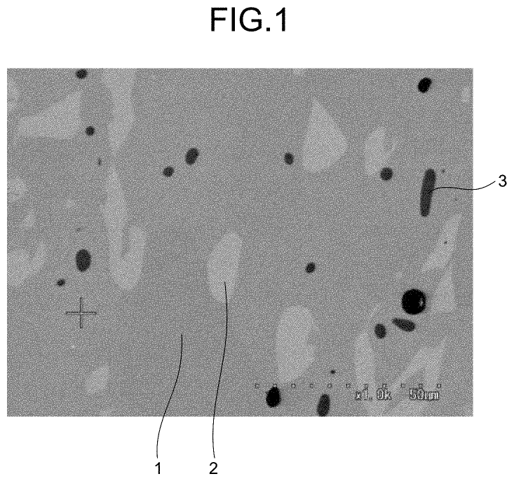

The magnet material includes a metal structure having a main phase. FIG. 1 is a cross-sectional schematic view illustrating a structural example of the metal structure. The magnet material includes the metal structure whose main phase 1 is a crystal phase containing high-concentration element M. It is possible to improve saturation magnetization by increasing an element M concentration in the main phase 1. The main phase is a phase having the highest volume occupancy ratio among crystal phases and amorphous phases in the magnet material. sub-phases 2 are phases having the volume occupancy ratio lower than the main phase 1. An example of a crystal phase containing the high-concentration element M includes, for example, a ThMn₁₂ crystal phase. The ThMn₁₂ crystal phase has a tetragonal system crystal structure.

The magnet material whose main phase 1 is the ThMn₁₂ crystal phase often contains phases containing rare-earth elements and transition metal elements and having a crystal structure similar to a crystal structure of the ThMn₁₂ crystal phase as the sub-phases 2. The sub-phase 2 is at least one crystal phase selected from the group consisting of, for example, a Th₂Zn₁₇ crystal phase, a Th₂Ni₁₇ crystal phase, a TbCu₇ crystal phase, and an Nd₃(Fe, Ti)₂₉ crystal phase. Since the contained element M concentrations of these crystal phases are lower than that of the ThMn₁₂ crystal phase, saturation magnetization thereof is low. Accordingly, the saturation magnetization of the magnet material is lowered when a precipitation amount of the sub-phases 2 increases.

In the magnet material of this embodiment, each element concentration of the magnet material is controlled, and the magnet material is produced under proper conditions to thereby reduce the sub-phases 2 while accelerating generation of the ThMn₁₂ crystal phase. It is thereby possible to suppress the lowering of the saturation magnetization of the magnet material.

A total amount of the sub-phases 2 is 20 volume % or less, more preferably 15 volume % or less, further preferably 10 volume % or less, and still further preferably 5 volume % or less. When the total amount of the sub-phases 2 exceeds 20 volume %, the saturation magnetization is likely to be lowered.

In the magnet material whose main phase 1 is the ThMn₁₂ crystal phase, at least one hetero-phase 3 selected from the group consisting of an α-Fe phase and an α-(Fe, Co) phase is likely to precipitate because an element M concentration is high. If the hetero-phases 3 precipitate, the element M concentration in the main phase decreases to cause the saturation magnetization lowering of the main phase 1. The precipitation of the hetero-phases 3 causes lowering of a coercive force of a permanent magnet.

In the magnet material of this embodiment, the hetero-phases 3 are reduced while forming the stable ThMn₁₂ crystal phase by controlling each element concentration of the magnet material and producing under proper conditions. It is thereby possible to increase the element M concentration in the main phase 1 and to suppress the lowering of the saturation magnetization of the magnet material.

An average crystal grain size of the main phase 1 is 4 μm or more, more preferably 7 μm or more, further preferably 10 μm or more, and still further preferably 20 μm or more. When the permanent magnet is produced from the magnet material, there is generally a process where powder of the magnet material (also called magnet powder) is pressed while oriented in a magnetic field. An easy magnetization axis direction of each magnetic powder is thereby aligned to a magnetic field applying direction, and for example, high residual magnetization can be obtained, resulting in increasing magnetic force of the permanent magnet. In this process, it is important to increase a degree of orientation which is an index expressing a degree of orientation of the easy magnetization axis direction of the magnetic powder to the magnetic field applying direction.

It is effective to increase an applied magnetic field, to reduce friction between particles of powder with each other, or between powder and a mold, and so on in order to increase the degree of orientation, but it can be cited as one of important factors that an average crystal grain size of a magnetic phase (main phase 1) is a proper size. This is because driving force to rotate the magnetic powder by the magnetic field depends on a vector product (torque) of an external magnetic field and a magnetic moment of the magnetic powder, and larger torque is likely to be obtained as the average crystal grain size of the main phase 1 is larger. In general, the magnetic moment of the main phase 1 of the magnet material before the magnetic field orientation is isotropic, and when a plurality of crystal grains are contained in the magnetic powder after pulverization, the easy magnetization axis of a whole of the magnetic powder becomes isotropic, and the degree of orientation is difficult to increase. According to a general manufacturing method of the permanent magnet, there is an optimum grain size distribution of the magnetic powder, and the average crystal grain size of the main phase 1 is preferably an average powder grain size of the magnetic powder or more. When the average crystal grain size of the main phase 1 is too coarse, it is not preferable in terms of productivity because heat treatment for a long time is necessary to obtain homogeneous and coarse grains. The average crystal grain size of the main phase 1 is preferably 150 μm or less.

The magnet material of this embodiment has a high degree of orientation when it is magnetic-field oriented. The degree of orientation can be expressed by a ratio (M_{hard}/M_{easy}) of magnetization in a hard magnetization axis direction (M_{hard}) with respect to magnetization in an easy magnetization axis direction (M_{easy}) when an external magnetic field of 1000 kA/m is applied by orienting the magnetic powder in the magnetic field, and then measuring an M-H curve in a magnetic field applying direction (the easy magnetization axis direction) and an M-H curve in a direction perpendicular thereto (the hard magnetization axis direction).

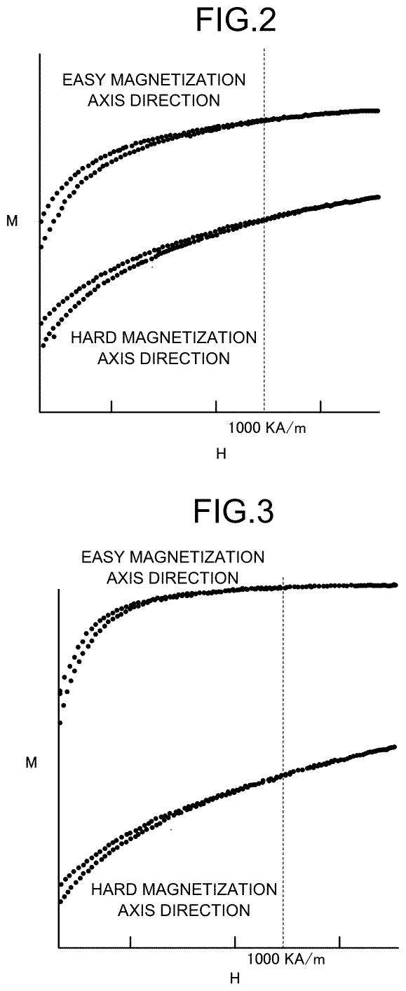

FIG. 2 and FIG. 3 are each a schematic view of M-H curves of magnetic materials. In each of FIG. 2 and FIG. 3, a horizontal axis represents a magnetic field H, and a vertical axis represents magnetization M. The M-H curves illustrated in FIG. 2 indicate that the degree of orientation is low. The M-H curves illustrated in FIG. 3 indicate that the degree of orientation is high. In a completely isotropic magnet material, since the M-H curve in the easy magnetization axis direction and the M-H curve in the hard magnetization axis direction are coincide, the index (M_{hard}/M_{easy}) is one. When the degree of orientation improves, the M-H curve in the easy magnetization axis direction and the M-H curve in the hard magnetization axis direction deviate from one another, and the index is a value smaller than one. The ratio M_{hard}/M_{easy} is preferably 0.6 or less, more preferably 0.57 or less, further preferably 0.55 or less, and still further preferably 0.50 or less.

The magnet material of this embodiment is expressed by a composition formula 1: (R₁₋ₓYₓ)ₐM_{b}T_{c}, where R is one element selected from the group consisting of rare-earth elements, T is at least one element selected from the group consisting of Ti, V, Nb, Ta, Mo, and W, M is Fe or Fe and Co, x is a number satisfying 0.01≤x≤0.8, a is a number satisfying 4≤a≤20 atomic %, c is a number satisfying 0<c<7 atomic %, and b is a number satisfying b=100−a−c atomic %. The magnet material may contain inevitable impurities.

Yttrium (Y) is an element effective for stabilization of the ThMn₁₂ crystal phase. That is, the element Y is able to increase the stability of the ThMn₁₂ crystal phase by mainly being replaced with the element R in the main phase 1 and contracting a crystal lattice, and so on. When an addition amount of the element Y is too small, the effect to increase the stability of the ThMn₁₂ crystal phase cannot be sufficiently obtained. When the addition amount of the element Y is too much, an anisotropy field of the magnet material is remarkably lowered. The reference sign x is preferably a number satisfying 0.01≤x≤0.8, more preferably a number satisfying 0.05≤x<0.5, and further preferably a number satisfying 0.1≤x≤0.4.

Fifty atomic % or less of the element Y may be replaced by at least one element selected from the group consisting of zirconium (Zr) and hafnium (Hf). The element Zr and the element Hf are elements effective for stabilization of a crystal phase.

The element R is a rare-earth element, brings about large magnetic anisotropy to the magnet material, and gives high coercive force to the permanent magnet. The element R is concretely at least one element selected from the group consisting of lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu), and the use of Sm is especially preferable. For example, when a plurality of elements including Sm are used as the element R, performance of the magnet material, for example, the coercive force can be increased by setting an Sm concentration to 50 atomic % or more of a whole of the elements applicable as the element R.

A concentration a of the element R and the element Y is preferably a number satisfying, for example, 4≤a≤20 atomic %. When the concentration is less than 4 atomic %, a lot of hetero-phases 3 precipitate to lower the coercive force. When the concentration exceeds 20 atomic %, the sub-phases 2 increase to lower the saturation magnetization of the whole of the magnet material. The concentration a of the element R and the element Y is more preferably a number satisfying 5≤a≤18 atomic %, and further preferably a number satisfying 7≤a≤15 atomic %.

The element M is Fe or Fe and Co, and is an element responsible for high saturation magnetization of the magnet material. Fe is an essential element and 30 atomic % or more of the element M is Fe because Fe has higher magnetization when Fe and Co are compared. A Curie temperature of the magnet material increases by adding Co to the element M, and lowering of the saturation magnetization at a high-temperature region can be suppressed. In addition, the saturation magnetization can be increased by adding a small amount of Co compared to a case of Fe is used independently. Meanwhile, increase in a Co ratio causes lowering of the anisotropy field. Further, too much Co ratio also causes lowering of the saturation magnetization. Accordingly, the high saturation magnetization, the high anisotropy field, and the high Curie temperature can be simultaneously obtained by properly controlling the ratio between Fe and Co. When M in the composition formula is expressed by (Fe_{1-y}Co_{y}), y is preferably 0.01≤y<0.7, more preferably 0.01≤y<0.5, and further preferably 0.01≤y≤0.3. Twenty atomic % or less of the element M may be replaced by at least one element selected from the group consisting of aluminum (Al), silicon (Si), chromium (Cr), manganese (Mg), nickel (Ni), and gallium (Ga). The above-stated elements contribute to, for example, growth of crystal grains forming the main phase 1.

The element T is at least one element selected from the group consisting of, for example, titanium (Ti), vanadium (V), niobium (Nb), tantalum (Ta), molybdenum (Mo), and tungsten (W). The ThMn₁₂ crystal phase can be stabilized by adding the element T. However, an element M concentration is lowered due to introduction of the element T resulting in that the saturation magnetization of the magnet material is likely to be lowered. An addition amount c of the element T may be decreased in order to increase the element M concentration, but in this case, the stability of the ThMn₁₂ crystal phase is lost, and the coercive force of the magnet material is lowered due to precipitation of the hetero-phases 3. An addition amount c of the element T is preferably a number satisfying 0<c<7 atomic %. It is thereby possible to stabilize the ThMn₁₂ crystal phase while suppressing the precipitation of the hetero-phases 3. Fifty atomic % or more of the element T is more preferably Ti or Nb. By using Ti or Nb, the precipitation amount of the hetero-phases 3 can be greatly reduced while stabilizing the ThMn₁₂ crystal phase even if the content of the element T is made small.

The addition amount of the element T is preferably small in order to further improve the saturation magnetization of the magnet material, but when the addition amount of the element T is small, an Nd₃(Fe, Ti)₂₉ crystal phase is likely to precipitate, and the saturation magnetization may be conversely lowered. It is effective to increase the addition amount of Y in order to suppress the precipitation of the Nd₃(Fe, Ti)₂₉ crystal phase even when the addition amount of the element T is small, and the high saturation magnetization is thereby obtained. For example, when the addition amount “c” of the element T is a number satisfying 0<c<4.5 atomic %, x is preferably a number satisfying 0.1<x<0.6, when c is a number satisfying 1.5<c<4 atomic %, x is preferably a number satisfying 0.15<x≤0.55, and when c is a number satisfying 3<c≤3.8 atomic %, x is preferably a number satisfying 0.3<x≤0.5.

The magnet material of this embodiment may further contain the element A. At this time, the composition of the magnet material is expressed by a composition formula 2: (R₁₋ₓYₓ)ₐM_{b}T_{c}A_{d} (where R is one element selected from the group consisting of rare-earth elements, T is at least one element selected from the group consisting of Ti, V, Nb, Ta, Mo, and W, M is Fe or Fe and Co, A is at least one element selected from the group consisting of N, C, B, H and P, x is a number satisfying 0.01≤x≤0.8, a is a number satisfying 4≤a≤20 atomic %, c is a number satisfying 0<c<7 atomic %, b is a number satisfying b=100−a−c−d atomic %, and d is a number satisfying 0<d<18 atomic %.

The element A is at least one element selected from the group consisting of nitrogen (N), carbon (C), boron (B), hydrogen (H), and phosphorus (P). The element A enters an inside of the crystal lattice of the ThMn₁₂ crystal phase, and has a function to generate, for example, at least one of enlarging the crystal lattice and changing an electronic structure. It is thereby possible to change the Curie temperature, the magnetic anisotropy, and the saturation magnetization. The element A is not necessarily added except inevitable impurities.

When 50 atomic % or more of the element R is Sm (when a main component of the element R is Sm), the magnetic anisotropy of the ThMn₁₂ crystal phase changes from a c axis direction to an in-plane which is perpendicular to the c axis due to the entrance of the element A, to decrease the coercive force. The element A is therefore preferably not added except the inevitable impurities. Meanwhile, when 50 atomic % or more of the element R is at least one element selected from the group consisting of Ce, Pr, Nd, Tb, and Dy (when the main component of the element R is at least one element selected from the group made up of Ce, Pr, Nd, Tb, and Dy), the magnetic anisotropy of the ThMn₁₂ crystal phase changes from the in-plane which is perpendicular to the c axis to the c axis direction due to the entrance of the element A, to thereby increase the coercive force. The element A is therefore preferably added. When the element A exceeds 18 atomic %, the stability of the ThMn₁₂ crystal phase is lowered. It is more preferable that d is a number satisfying 0<d≤14 atomic %.

A composition of the magnet material is measured by, for example, an inductively coupled plasma-atomic emission spectroscopy: ICP-AES method, a scanning electron microscope-energy dispersive X-ray spectroscopy: SEM-EDX method, a transmission electron microscope-energy dispersive X-ray spectroscopy: TEM-EDX method, and so on. A volume ratio of each phase is comprehensively determined by using both observations through an electron microscope and an optical microscope, X-ray diffraction, and so on.

A concentration of each element of the main phase 1 is measured by using, for example, SEM-EDX. For example, the main phase 1 can be specified from an observation image by SEM and a mapping image of each element of measurement samples of the magnet material by SEM-EDX.

A volume ratio of each phase of a metal structure is comprehensively determined by using, for example, both the observation through the electron microscope and the optical microscope, the X-ray diffraction, and so on, but it can be found by an areal analysis method of an SEM image which photographs a cross section of the magnet material. A cross section of a substantially center part of a surface having the largest area in a sample is used as the cross section of the magnet material. In SEM, for example, a region of 100 μm×200 μm or more and 300 μm×500 μm or less is observed with a magnification of 500 times. The observations are performed at 10 locations or more which do not overlap with each other, an average value of calculated area ratios in respective images is found where a maximum value and a minimum value are excluded, and this value is set as a volume ratio of each phase.

Total amounts of the sub-phases 2 and the hetero-phases 3 are respectively expressed by S_{sub}/Sₜₒₜₐₗ×100 or S_{Fe, Co}/Sₜₒₜₐₗ×100 by using an area Sₜₒₜₐₗ, a total sum of areas of the sub-phases 2 S_{sub} and a total sum of areas of the hetero-phases 3 S_{Fe, Co} of the SEM image as illustrated in FIG. 1.

An average crystal grain size of the main phase 1 can be found from the SEM image. In the above-stated observation surface, a length in a longitudinal direction of a grain which is identified as the main phase 1 is set as a grain size. Each crystal grain where an entire crystal grain can be seen within an observation range is measured, approximately 100 points are measured with respect to one magnet material, and an average value of values where a maximum value and a minimum value are excluded is set as the average crystal grain size of the main phase 1.

Magnetic properties such as the saturation magnetization of the magnet material are calculated by using, for example, a vibrating sample magnetometer: VSM. The saturation magnetization of the magnet material is 1.4 T or more, preferably 1.45 T or more, further preferably 1.48 T or more, and still further preferably 1.50 T or more. An upper limit of the saturation magnetization is not particularly limited, but it is for example, 1.7 T or more.

Next, a manufacturing method example of the magnet material of this embodiment is described. First, an alloy containing predetermined elements required for the magnet material is manufactured. For example, an alloy can be manufactured by using an arc melting method, a high-frequency melting method, a mold casting method, a mechanical alloying method, a mechanical grinding method, a gas atomization method, a reduction diffusion method, and the like.

As a method to produce a magnet material whose main phase 1 is a phase having a high element M concentration such as the ThMn₁₂ crystal phase, there are known methods using a strip cast method, a liquid quenching method, and the like. These methods are production methods quenching a molten alloy, and are methods effective for increasing the stability of the ThMn₁₂ crystal phase. However, the main phase 1 after the cooling becomes fine through the method quenching the molten alloy, and it is difficult to increase the degree of orientation by the magnetic field orientation due to the above-stated reasons. Heat treatment or the like becomes necessary to grow the crystal grains in order to increase the degree of orientation, but it results in lowering of productivity because control for a composition fluctuation due to the heat treatment and deterioration suppression due to oxidation are required, and treatment for a long time is necessary.

In this embodiment, the ThMn₁₂ crystal phase can be stably produced while suppressing the precipitation of the sub-phases 2 and the hetero-phases 3 without passing through the quenching process of the molten alloy by subjecting a massive alloy which is produced by properly controlling each element concentration to the heat treatment at an appropriate temperature and retention time. It is thereby possible to produce the magnet material having the main phase 1 having a sufficient size without lowering the productivity.

Heating is performed at a temperature of, for example, 800° C. or more and 1350° C. or less for one hour or more and 120 hours or less as the heat treatment. The stability of the ThMn₁₂ crystal phase is thereby increased, the sub-phases 2 are likely to be formed, and both properties of the saturation magnetization and the coercive force can be further improved.

When the heat treatment temperature is lower than 800° C., the precipitation amount of the sub-phases 2 becomes large to cause the lowering of the saturation magnetization. The heat treatment at a temperature as high as possible is preferable in order to suppress the precipitation of the sub-phases 2. Meanwhile, when the heat treatment temperature is higher than 1350° C., the precipitation of the hetero-phases 3 becomes large to cause the lowering of the coercive force of the permanent magnet which is manufactured from this alloy. Besides, the alloy is partly melted, and the productivity remarkable decreases. The heat treatment temperature is more preferably 900° C. or more and 1320° C. or less, further preferably 1000° C. or more and 1300° C. or less, still further preferably 1100° C. or more and 1290° C. or less, yet further preferably 1150° C. or more and 1280° C. or less, and still yet further preferably 1200° C. or more and 1250° C. or less.

The element A may be made enter the alloy. The alloy is preferably pulverized into powder before the process of making the element A enter the alloy. When the element A is nitrogen, the alloy can be nitrided and the element N can be made enter the alloy by heating the alloy in an atmosphere of nitrogen gas, ammonia gas, and the like at approximately 0.1 atmosphere or more and 100 atmosphere or less, at a temperature of 200° C. or more and 700° C. or less, for one hour or more and 100 hours or less. When the element A is carbon, the alloy can be carbonized and the element C can be made enter the alloy by heating the alloy in an atmosphere of C₂H₂, CH₄, C₃H₈, or CO gas, methanol pyrolysis gas, and the like at approximately 0.1 atmosphere or more and 100 atmosphere or less, at a temperature of 300° C. or more and 900° C. or less, for one hour or more and 100 hours or less. When the element A is hydrogen, the alloy can be hydrogenized and the element H can be made enter the alloy by heating the alloy in an atmosphere of hydrogen gas, ammonia gas, and the like at approximately 0.1 atmosphere or more and 100 atmosphere or less, at a temperature range from 200° C. or more to 700° C. or less, for one hour or more and 100 hours or less. When the element A is boron, the alloy can contain boron by adding boron to raw materials when the alloy is manufactured. When the element A is phosphorus, the alloy is phosphorized and the element P can be made enter the alloy.

The magnet material is manufactured through the above-stated processes. Further, the permanent magnet is manufactured by using the magnet material. For example, the magnet material is pulverized, pressure-molded in the magnetic field and then subjected to heat treatment such as sintering, resulting in that a sintered magnet containing a sintered compact of the magnet material is manufactured. Besides, a bond magnet containing the magnet material is manufactured by pulverizing the magnet material and solidifying with resin or the like.

### Second Embodiment

The permanent magnet including the magnet material according to the first embodiment can be used for various motors and generators. Further, the permanent magnet is able to be used as a stationary magnet and a variable magnet of variable magnetic flux motors and variable magnetic flux generators. The permanent magnet of the first embodiment is used to constitute various motors and generators. When the permanent magnet of the first embodiment is applied to a variable magnetic flux motor, for example, technology disclosed in Japanese Patent Application Laid-open No. 2008-29148 or Japanese Patent Application Laid-open No. 2008-43172 can be applied to a configuration and a drive system of the variable magnetic flux motor.

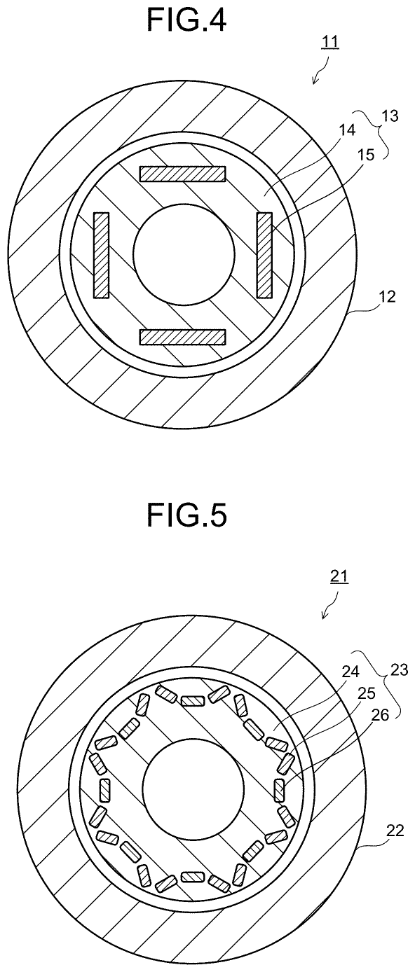

Next, a motor and a generator including the permanent magnet will be described with reference to the drawings. FIG. 4 is a view illustrating a permanent magnet motor. In a permanent magnet motor 11 illustrated in FIG. 4, a rotor 13 is disposed in a stator 12. In an iron core 14 of the rotor 13, permanent magnets 15 which are the permanent magnets of the first embodiment are disposed. By using the permanent magnets of the first embodiment, efficiency increase, size reduction, cost reduction, and the like of the permanent magnet motor 11 can be achieved based on properties of respective permanent magnets, and the like.

FIG. 5 is a view illustrating a variable magnetic flux motor. In a variable magnetic flux motor 21 illustrated in FIG. 5, a rotor 23 is disposed in a stator 22. In an iron core 24 of the rotor 23, permanent magnets of the first embodiment are disposed as stationary magnets 25 and variable magnets 26. A magnetic flux density (magnetic flux amount) of the variable magnets 26 is variable. The variable magnets 26 have a magnetization direction perpendicular to a Q-axis direction and hence is not affected by a Q-axis current, and can be magnetized by a D-axis current. The rotor 23 is provided with a magnetization winding (not illustrated). It is structured such that by passing a current from a magnetization circuit through this magnetization winding, a magnetic field thereof directly acts on the variable magnets 26.

The permanent magnet of the first embodiment enables to obtain preferred coercive force in the stationary magnet 25. When the permanent magnet of the first embodiment is applied to the variable magnet 26, the coercive force may be controlled to be in the range of, for example, 100 kA/m or more and 500 kA/m or less by changing various manufacturing conditions. Note that in the variable magnetic flux motor 21 illustrated in FIG. 5, although the permanent magnets of the first embodiment can be used for both the stationary magnets 25 and the variable magnets 26, the permanent magnets of the first embodiment may be used for either one of the magnets. The variable magnetic flux motor 21 is able to output large torque with a small device size, and thus is preferred for motors of hybrid vehicles, electric vehicles, and the like for which high power and small size of a motor are required.

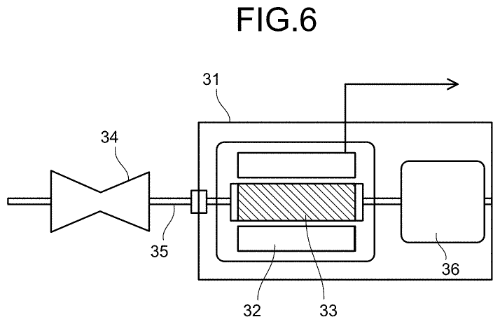

FIG. 6 illustrates a generator. A generator 31 illustrated in FIG. 6 has a stator 32 using the permanent magnet. A rotor 33 disposed inside the stator 32 is connected to a turbine 34 provided on one end of the generator 31 through a shaft 35. The turbine 34 is rotated by fluid supplied from the outside, for example. In addition, it is also possible to rotate the shaft 35 by transmitting kinetic rotations such as regenerative energy of an automobile, instead of the turbine 34 rotated by fluid. Various publicly known structures can be employed for the stator 32 and the rotor 33.

The shaft 35 is in contact with a commutator (not illustrated) disposed on an opposite side of the turbine 34 with respect to the rotor 33, and electromotive force generated by rotations of the rotor 33 is increased in voltage to a system voltage and transmitted as output of the generator 31 through an isolated phase bus and a main transformer (not illustrated). The generator 31 may be either of an ordinary generator and a variable magnetic flux generator. Note that static electricity from the turbine 34 or electrostatic charge by an axial current accompanying power generation occurs on the rotor 33. Accordingly, the generator 31 has a brush 36 for discharging the electrostatic charges of the rotor 33.

By applying the permanent magnet to a generator as above, effects such as efficiency increase, size reduction, and cost reduction can be obtained.

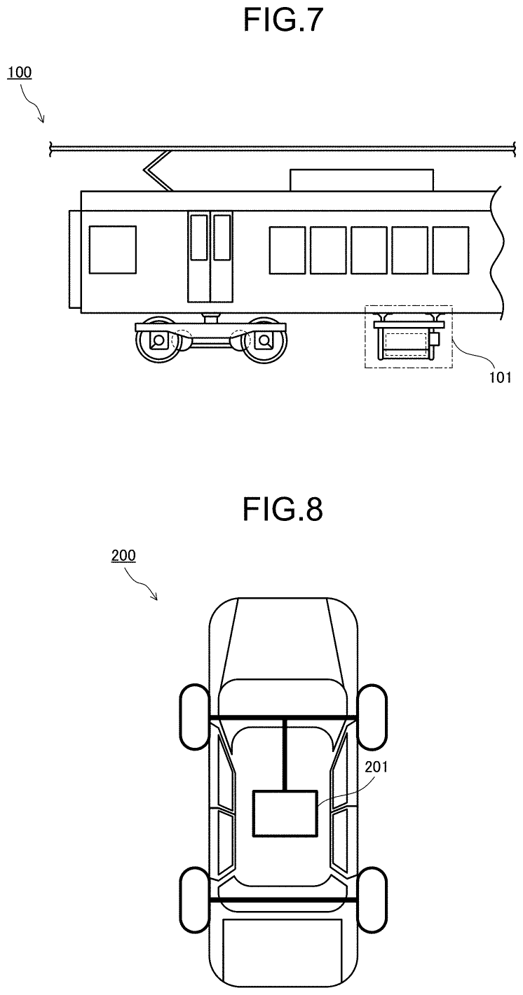

The rotary electric machine may be mounted on, for example, a railway vehicle (an example of a vehicle) used for railway traffic. FIG. 7 is a view illustrating an example of a railway vehicle 100 including a rotary electric machine 101. The motors in FIG. 4 and FIG. 5, the generator in FIG. 6, and so on can be used as the rotary electric machine 101. When the rotary electric machine is mounted as the rotary electric machine 101, the rotary electric machine 101 may be used as, for example, an electric motor which outputs driving force by using electric power supplied from an overhead line and electric power supplied from secondary batteries mounted on the railway vehicle 100, and may be used as a generator which supplies electric power to various loads in the railway vehicle 100 by converting kinetic energy into electric power. By using the high-efficiency rotary electric machine such as the rotary electric machine of this embodiment, the railway vehicle can be traveled while saving energy.

The rotary electric machine may be mounted on an automobile (another example of a vehicle) such as hybrid vehicles and electric vehicles. FIG. 8 is a view illustrating an example of an automobile 200 including a rotary electric machine 201. The motors in FIGS. 4, 5, the generator in FIG. 6, and so on can be used as the rotary electric machine 201. When the rotary electric machine is mounted as the rotary electric machine 201, the rotary electric machine 201 may be used as an electric motor which outputs driving force of the automobile 200 or a generator which converts kinetic energy at a driving time of the automobile 200 into electric power. Besides, the rotary electric machine may be mounted on, for example, industrial apparatuses (industrial motors), air-conditioning apparatuses (air-conditioners, water heater compressor motors), wind power generators, or lifts (hoists).

### EXAMPLES

### Examples 1 to 5

Raw materials were weighed in proper quantity and then an alloy was produced by using the arc-melting method. Next, a magnet material was obtained by heating the alloy under an Ar atmosphere, at 1200° C., for 25 hours.

A composition analysis was performed for the obtained magnet material by using ICP-AES. The composition of the magnet material found by using ICP-AES was listed in Table 1. A cross-sectional SEM observation was performed to find total amounts of sub-phases and hetero-phases and an average crystal grain size of a main phase. The magnet material was pulverized in a mortar into a powder state, then solidified by using paraffin while applying a magnetic field, and magnetic properties were measured by VSM to find the saturation magnetization and the degree of orientation (M_{hard}/M_{easy}). Each measurement value was listed in Table 2.

### Example 6

Raw materials were weighed in proper quantity and then an alloy was produced by using the arc-melting method. Next, the alloy was heated under the Ar atmosphere, at 1250° C., for 10 hours. After that, the alloy was pulverized in a mortar, and a magnet material was obtained by heating the obtained powder under the nitrogen gas atmosphere, at 450° C. for four hours.

A composition analysis was performed for the obtained magnet material by using ICP-AES. The composition of the magnet material found by using ICP-AES was listed in Table 1. A cross-sectional SEM observation was performed to find total amounts of sub-phases and hetero-phases and an average crystal grain size of a main phase. The magnet material was pulverized in a mortar into a powder state, solidified by using paraffin while applying a magnetic field, magnetic properties were measured by VSM to find the saturation magnetization and the degree of orientation (M_{hard}/M_{easy}). Each measurement value was listed in Table 2.

### Comparative Example 1

Raw materials were weighed in proper quantity and then an alloy was produced by using the arc-melting method. Next, a magnet material was obtained by heating the alloy under the Ar atmosphere, at 700° C., for 100 hours.

A composition analysis was performed for the obtained magnet material by using ICP-AES. The composition of the magnet material found by using ICP-AES was listed in Table 1. A cross-sectional SEM observation was performed to find total amounts of sub-phases and hetero-phases and an average crystal grain size of a main phase. The magnet material was pulverized in a mortar into a powder state, then solidified by using paraffin while applying a magnetic field, and magnetic properties were measured by VSM to find the saturation magnetization and the degree of orientation (M_{hard}/M_{easy}). Each measurement value was listed in Table 2.

### Comparative Example 2

Raw materials were weighed in proper quantity and then an alloy was produced by using the arc-melting method. Next, the alloy was melted, and a quenched ribbon was produced by injecting the obtained molten metal into a Cu roll which rotates at a roll peripheral speed of 10 m/s. A magnet material was obtained by heating the obtained alloy ribbon under the Ar atmosphere, at 1000° C., for four hours.

A composition analysis was performed for the obtained magnet material by using ICP-AES. The composition of the magnet material found by using ICP-AES was listed in Table 1. A cross-sectional SEM observation was performed to find total amounts of sub-phases and hetero-phases and an average crystal grain size of a main phase. The magnet material was pulverized in a mortar into a powder state, then solidified by using paraffin while applying a magnetic field, and magnetic properties were measured by VSM to find the saturation magnetization and the degree of orientation (M_{hard}/M_{easy}). Each measurement value was listed in Table 2.

TABLE 1

| | Composition Of Magnet Material |
|---|---|
| Example 1 | (Sm_{0.80}Y_{0.20})_{7.7}(Fe_{0.80}Co_{0.20})_{88.4}Ti_{3.9} |
| Example 2 | (Sm_{0.83}Y_{0.17})_{7.5}(Fe_{0.70}Co_{0.30})_{88.9}Nb_{3.6} |
| Example 3 | (Sm_{0.6}Y_{0.4})_{7.6}(Fe_{0.80}Co_{0.20})_{88.9}Ti_{3.5} |
| Example 4 | (Sm_{0.7}Y_{0.3})_{7.5}(Fe_{0.70}Co_{0.30})_{88.9}Ti_{2.5}V_{1.1} |
| Example 5 | (Sm_{0.72}Y_{0.14}Zr_{0.14})_{7.5}(Fe_{0.70}Co_{0.30})_{88.5}Ti_{4.0} |
| Example 6 | (Nd_{0.72}Y_{0.28})_{7.5}(Fe_{0.70}C0_{0.30})_{82.2}Nb_{3.5}N_{6.8} |
| Comparative Example 1 | (Sm_{0.5}Y_{0.5})_{8.2}(Fe_{0.70}Co_{0.30})_{88.3}Nb_{3.5} |
| Comparative Example 2 | (Sm_{0.7}Y_{0.3})_{7.5}(Fe_{0.70}Co_{0.30})_{88.9}Ti_{3.6} |

TABLE 2

| | Saturation | | | Average Crystal | |
|---|---|---|---|---|---|
| | Magnetization | Total Amount | Total Amount of | Grain Size of | |
| | of Magnet Material | of Sub-Phases | Hetero-Phases | Main Phase | |
| | (T) | (volume %) | (volume %) | (μm) | M_{hard}/M_{easy} |
| Example 1 | 1.52 | 3 | 0.7 | 50 | 0.52 |
| Example 2 | 1.54 | 5 | 0.5 | 45 | 0.50 |
| Example 3 | 1.57 | 10 | 0.6 | 53 | 0.53 |
| Example 4 | 1.52 | 7 | 1.0 | 41 | 0.52 |
| Example 5 | 1.51 | 4 | 0.3 | 60 | 0.50 |
| Example 6 | 1.55 | 3 | 1.1 | 52 | 0.54 |
| Comparative Example 1 | 1.38 | 30 | 1.0 | 47 | 0.55 |
| Comparative Example 2 | 1.54 | 3 | 0.5 | 3 | 0.65 |

As it can be seen from Table 2, in each of the magnetic materials of Examples 1 to 6, the precipitation amounts of the sub-phases and the hetero-phases are small and the saturation magnetization is high. The average crystal grain size of the main phase is 4 μm or more, and the degree of orientation is high.

On the other hand, in the magnet material of Comparative Example 1, the precipitation amount of the sub-phases is particularly large, and the saturation magnetization is low. In Comparative Example 2, the average crystal grain size of the main phase is less than 4 μm, and the degree of orientation (M_{hard}/M_{easy}) is low.

Each of values of the saturation magnetization of each of Examples 1 to 6 and Comparative Examples 1 to 2 depends on a value of an applied magnetic field which is used for evaluation.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnet material expressed by
a composition formula 1: (R₁₋ₓYₓ)ₐM_{b}T_{c}
where R is at least one element selected from the group consisting of rare-earth elements, T is at least one element selected from the group consisting of Ti, V, Nb, Ta, Mo, and W, M is Fe or Fe and Co, x is a number satisfying 0.01≤x≤0.8, a is a number satisfying 4≤a≤20 atomic %, c is a number satisfying 0<c<7 atomic %, and b is a number satisfying b=100−a−c atomic %,
the magnet material comprising
a main phase having a ThMn₁₂ crystal phase, wherein
a total amount of at least one sub-phase selected from the group consisting of a Th₂Zn₁₇ crystal phase, a Th₂Ni₁₇ crystal phase, a TbCu₇ crystal phase, and an Nd₃(Fe, Ti)₂₉ crystal phase is 20 volume % or less,
a total amount of at least one hetero-phase selected from the group consisting of an α-Fe phase and an α-(Fe, Co) phase is 5 volume % or less, and
an average crystal grain size of the main phase is 4 μm or more.

2. The magnet material according to claim 1, wherein
50 atomic % or more of the element R is Sm.

3. The magnet material according to claim 1, wherein
50 atomic % or less of the element Y is replaced by at least one element selected from the group consisting of Zr and Hf.

4. The magnet material according to claim 1, wherein
50 atomic % or more of the element T is Ti or Nb.

5. The magnet material according to claim 1, wherein
20 atomic % or less of the element M is replaced by at least one element selected from the group consisting of Al, Si, Cr, Mn, Ni, and Ga.

6. A magnet material expressed by
a composition formula 2: (R₁₋ₓYₓ)ₐM_{b}T_{c}A_{d}
where R is one element selected from the group consisting of rare-earth elements, T is at least one element selected from the group consisting of Ti, V, Nb, Ta, Mo, and W, M is Fe or Fe and Co, A is at least one element selected from the group consisting of N, C, B, H and P, x is a number satisfying 0.01≤x≤0.8, a is a number satisfying 4≤a≤20 atomic %, c is a number satisfying 0<c<7 atomic %, b is a number satisfying b=100−a−c−d atomic %, and d is a number satisfying 0<d≤18 atomic %,
the magnet material comprising
a main phase having a ThMn₁₂ crystal phase, wherein
a total amount of at least one sub-phase selected from the group consisting of a Th₂Zn₁₇ crystal phase, a Th₂Ni₁₇ crystal phase, a TbCu₇ crystal phase, and an Nd₃(Fe, Ti)₂₉ crystal phase is 20 volume % or less,
a total amount of at least one hetero-phase selected from the group consisting of an α-Fe phase and an α-(Fe, Co) phase is 5 volume % or less, and
an average crystal grain size of the main phase is 4 μm or more.

7. The magnet material according to claim 6, wherein
d is the number satisfying 0<d≤18 atomic %, and
50 atomic % or more of the element R is at least one element selected from the group consisting of Ce, Pr, Nd, Tb, and Dy.

8. The magnet material according to claim 6, wherein
50 atomic % or less of the element Y is replaced by at least one element selected from the group consisting of Zr and Hf.

9. The magnet material according to claim 6, wherein
50 atomic % or more of the element T is Ti or Nb.

10. The magnet material according to claim 6, wherein
20 atomic % or less of the element M is replaced by at least one element selected from the group consisting of Al, Si, Cr, Mn, Ni, and Ga.

11. A permanent magnet comprising the magnet material according to claim 1.

12. A permanent magnet comprising a sintered compact of the magnet material according to claim 1.

13. A rotary electric machine comprising:
a stator; and
a rotor, wherein
the stator or the rotor includes the permanent magnet according to claim 12.

14. The rotary electric machine according to claim 13, wherein
the rotor is connected to a turbine through a shaft.

15. A vehicle comprising the rotary electric machine according to claim 13.

16. The vehicle according to claim 15, wherein
the rotor is connected to a shaft, and
rotation is transmitted to the shaft.
